(19) United States
(12) Patent Application Publication
(10) Pub. No.: US 2026/0158922 A1
(43) Pub. Date: Jun. 11, 2026

(54) CONTROL TECHNIQUES FOR ACTIVE DISCHARGE OF HIGH VOLTAGE CAPACITOR THROUGH VEHICLE ELECTRIC MOTOR WINDINGS

(71) Applicant: FCA US LLC, Auburn Hills, MI (US)

(72) Inventors: Diego Fernando Valencia Garcia, Auburn Hills, MI (US); Mustafa Mohamadian, Auburn Hills, MI (US)

(21) Appl. No.: 18/976,952

(22) Filed: Dec. 11, 2024

(51) Int. Cl. B60L 3/00; H01M 8/04303; H01M 8/04858; H01M 8/04955; H01M 10/44

(52) U.S. Cl. CPC B60L 3/0046; B60L 3/0053; H01M 8/04303; H01M 8/04865; H01M 8/04955; H01M 10/44; H01M 2220/20; H01M 2250/20

(57) ABSTRACT

An active discharge control method for an electrified vehicle includes providing an electric drive module (EDM) configured to generate drive torque for propulsion of the electrified vehicle, the EDM comprising a power inverter module (PIM) and an electric motor having a plurality of windings, wherein the PIM comprises a capacitor connected between the electric motor and an energy storage system (ESS) of the electrified vehicle, generating, by a control system of the electrified vehicle, direct and quadrature current commands, for controlling the EDM, using an unmodified maximum torque per amperage (MTPA) look-up table (LUT) and a torque command based on a driver torque request, and, in response to a discharge request for the capacitor, modifying, by the control system, at least one of the direct and quadrature current commands to cause a voltage of the capacitor to discharge through the plurality of windings of the electric motor.

### FIELD

The present application generally relates to electrified vehicles and, more particularly, to control techniques for active discharge of a high voltage capacitor through electric motor windings.

### BACKGROUND

An electrified vehicle includes a high voltage energy storage system (ESS), such as a high voltage battery pack, a fuel cell system, or a combination thereof. The ESS powers one or more electric drive modules (EDMs), each of which includes a power inverter module (PIM) and an electric motor. The PIM includes a high voltage capacitor that bridges the ESS and the EDM and provides a stable direct current (DC) voltage while suppressing the current fluctuations caused by the electric motor operation. Once the electrified vehicle enters key-off or during a crash condition, the capacitor DC voltage must be reduced below a certain level (e.g., 60V DC) to guarantee the safety of hardware and passengers. The capacitor DC voltage discharge must also be executed within a specific time interval (e.g., five seconds or less, per Regulation Number 94 of the Economic Commission for Europe of the United Nations, or UN/ECE). The capacitor DC voltage discharge is typically performed using a discharge resistor connected in parallel to the capacitor. This discharge resistor, however, is large/bulky, expensive, and heavy, especially in systems using 800V or higher rated voltages. Accordingly, while such conventional engine start-stop systems do work well for their intended purpose, there exists an opportunity for improvement in the relevant art.

### SUMMARY

According to one example aspect of the invention, an active discharge control system for an electrified vehicle is presented. In one exemplary implementation, the active discharge control system comprises an electric drive module (EDM) configured to generate drive torque for propulsion of the electrified vehicle, the EDM comprising a power inverter module (PIM) and an electric motor having a plurality of windings, wherein the PIM comprises a capacitor connected between the electric motor and an energy storage system (ESS) of the electrified vehicle, a control system configured to generate direct and quadrature current commands, for controlling the EDM, using an unmodified maximum torque per amperage (MTPA) look-up table (LUT) and a torque command based on a driver torque request and, in response to a discharge request for the capacitor, modify at least one of the direct and quadrature current commands to cause a voltage of the capacitor to discharge through the plurality of windings of the electric motor.

In some implementations, the control system is configured to modify at least one of the current commands to cause the voltage of the capacitor to discharge via at least one of first and second discharge modes, wherein the first discharge mode corresponds to a low speed region for a speed of the electric motor and the second discharge mode corresponds to a high speed region for the speed of the electric motor. In some implementations, the second discharge mode includes further includes the control system limiting the torque command for the EDM to prevent the capacitor from being recharged by a regenerating mode. In some implementations, the first discharge mode is initially entered in response to the discharge request or is transitioned to from the second discharge mode when the speed of the electric motor transitions from the high speed region to the low speed region.

In some implementations, the second discharge mode includes the control system increasing at least one of the direct and quadrature current commands output by the MTPA LUT. In some implementations, the first discharge mode includes the control system increasing the direct current command and setting the quadrature current command to zero. In some implementations, the control system is configured to discharge the voltage of the capacitor to below a voltage threshold within a time period. In some implementations, the voltage threshold is approximately 60V DC and the time period is approximately five seconds. In some implementations, the discharge request is generated in response to a key-off cycle of the electrified vehicle or a crash event of the electrified vehicle. In some implementations, the ESS comprises at least one of a high voltage battery pack or system and a fuel cell system.

According to another example aspect of the invention, an active discharge control method for an electrified vehicle is presented. In one exemplary implementation, the active discharge control method comprises providing an EDM configured to generate drive torque for propulsion of the electrified vehicle, the EDM comprising a PIM and an electric motor having a plurality of windings, wherein the PIM comprises a capacitor connected between the electric motor and an ESS of the electrified vehicle, generating, by a control system of the electrified vehicle, direct and quadrature current commands, for controlling the EDM, using an unmodified MTPA LUT and a torque command based on a driver torque request and, in response to a discharge request for the capacitor, modifying, by the control system, at least one of the direct and quadrature current commands to cause a voltage of the capacitor to discharge through the plurality of windings of the electric motor.

In some implementations, the modifying of the at least one of the current commands to cause the voltage of the capacitor to discharge is performed via at least one of first and second discharge modes, wherein the first discharge mode corresponds to a low speed region for a speed of the electric motor and the second discharge mode corresponds to a high speed region for the speed of the electric motor. In some implementations, the second discharge mode includes further includes the control system limiting the torque command for the EDM to prevent the capacitor from being recharged by a regenerating mode. In some implementations, the first discharge mode is initially entered in response to the discharge request or is transitioned to from the second discharge mode when the speed of the electric motor transitions from the high speed region to the low speed region.

In some implementations, the second discharge mode includes the control system increasing at least one of the direct and quadrature current commands output by the MTPA LUT. In some implementations, the first discharge mode includes the control system increasing the direct current command and setting the quadrature current command to zero. In some implementations, the control system is configured to discharge the voltage of the capacitor to below a voltage threshold within a time period. In some implementations, the voltage threshold is approximately 60V DC and the time period is approximately five seconds. In some implementations, the discharge request is generated in response to a key-off cycle of the electrified vehicle or a crash event of the electrified vehicle. In some implementations, the ESS comprises at least one of a high voltage battery pack or system and a fuel cell system.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example active discharge control system according to the principles of the present application;

FIG. 2 is a functional block diagram of an example system architecture for the active discharge control system according to the principles of the present application;

FIGS. 3A-3B are functional block diagrams of more example system architectures for the active discharge control system according to the principles of the present application; and

FIG. 4 is a flow diagram of an example active discharge control method for a capacitor of a power inverter module (PIM) of an electrified vehicle according to the principles of the present application.

### DESCRIPTION

As previously discussed, an electrified vehicle includes a high voltage energy storage system (ESS) that powers one or more electric drive modules (EDMs), each of which includes a power inverter module (PIM) and an electric motor. The PIM includes a high voltage capacitor that bridges the ESS and the EDM and provides a stable direct current (DC) voltage while suppressing the current fluctuations caused by the electric motor operation. Once the electrified vehicle enters key-off or during a crash condition, the capacitor DC voltage must be reduced below a certain level (e.g., 60V DC) to guarantee the safety of hardware and passengers. The capacitor DC voltage discharge must also be executed within a specific time interval (e.g., five seconds or less, per United Nation Vehicle Regulation ECC R94). The capacitor DC voltage discharge is typically performed using a discharge resistor connected in parallel to the capacitor. This discharge resistor, however, is large/bulky, expensive, and heavy, especially in systems using 800V or higher rated voltages.

Accordingly, control techniques to discharge the capacitor DC voltage through the electric motor's windings, thereby eliminating the need for a discharge resistor, are presented herein. The overall objective of active discharge control is to convert the energy stored in the capacitor into heat when commanded by supervisory control. The control algorithm operates as a function of the electric motor speed in one of two different modes. In a first mode (Mode 1), defined for low speed (idle) and standstill motor speeds, high current is injected to cause a fast discharge of the capacitor without producing electric motor torque. In a second mode (Mode 2), defined for high speed motor speeds, high current is injected to reduce the capacitor DC voltage and a limited torque is commanded to prevent the capacitor from being recharged by a regenerating mode. The second mode (Mode 2) is maintained until the electric motor's speed, and thus the back-electromotive force (EMF), are low enough to thereafter transition into the first mode (Mode 1). One primary benefit is not having to change the control architecture for the electric motors (e.g., a maximum torque per amperage look-up table, or MTPA LUT), which differs from other existing control techniques (e.g., six-step control). Other benefits include decreased cost/packaging/weight through the elimination of the discharge resistor.

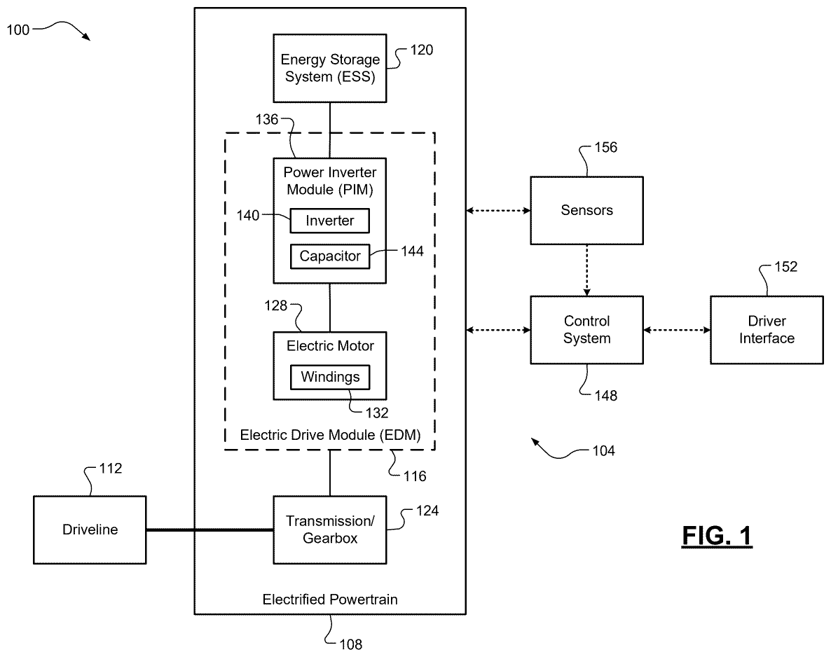

Referring now to FIG. 1, a functional block diagram of a vehicle 100 having an example active discharge control system 104 according to the principles of the present application is illustrated. The electrified vehicle 100 (also “vehicle 100” herein) generally comprises an electrified powertrain 108 configured to generate and transfer torque to a driveline 112 for propulsion. The electrified powertrain 108 comprises at least one EDM 116 that is powered by electrical energy supplied by an energy storage system (ESS) 120, which could be a high voltage battery pack or system, a fuel cell system, or some combination thereof. Each EDM 116 generates torque that is then transferred to the driveline 112 via a transmission or gearbox 124. The EDM 116 further comprises an electric motor 128 (e.g., a permanent magnet type motor), which includes a plurality of windings 132, and a power inverter module (PIM) 136, including an inverter 140 and a DC capacitor 144. The electrified powertrain 108 could also have a different configuration, such as a mild hybrid configuration with an internal combustion engine (not shown) that is associated with the EDM 136 for converting the engine's mechanical energy into electrical energy (e.g., by operating as a generator) for recharging the ESS 120. A control system 148 is configured to control operation of the electrified vehicle 100, which primarily includes controlling the electrified powertrain 108 to generate a sufficient amount of drive torque to satisfy a driver torque request provided via a driver interface 152 (e.g., an accelerator pedal).

The control system 148 receives measurements of various vehicle parameters (speeds, voltages/currents, temperatures, etc.) from a set of one or more sensors 156 that monitor operation of the electrified vehicle 100 including the electrified powertrain 108 and the driveline 112. The control system 148 is configured to execute an existing motor control architecture as described in greater detail below. The control system 148 is also configured to perform the active discharge control techniques of the present application, which do not require a substantial alteration or redesign of the existing motor control architecture (e.g., different LUTs). In one exemplary embodiment, the active discharge control techniques of the present application take advantage of a legacy function that guarantees closed-loop voltage control when the back-EMF is above a safe threshold. This “alternator mode” is a limp mode used in mild hybrid vehicle architectures (e.g., an engine and motor-generator unit, or MGU, as discussed above) when the ESS 120 is unavailable to charge a low voltage (e.g., 12V) battery (not shown).

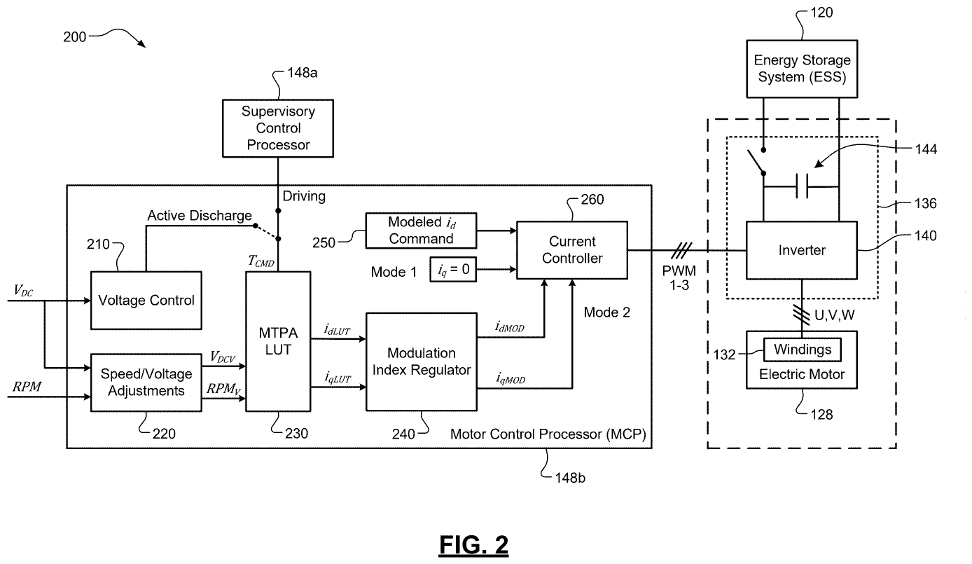

Referring now to FIG. 2 and with continued reference to FIG. 1, a functional block diagram of an example system architecture 200 for the active discharge control system 104 according to the principles of the present application is illustrated. As illustrated, FIG. 2 depicts the controls architecture used in a motor control processor (MCP) 148b of the control system 148, which further includes a supervisory control processor 148a. Under normal operation, the supervisory control processor 148a defines a torque command, which is mapped through a maximum torque-per-amperage (MTPA) LUT (or multiple LUTs) 230 into current references i_{dLUT}, i_{qLUT}. This MTPA LUT 230 is defined only within a limited voltage operating range, around the expected battery voltage operating range during driving. In a first active discharge mode (Mode 1), the overall torque path is bypassed by the current command. The current to be injected must discharge the capacitor 144 without producing torque since standstill condition is assumed; and thus the q-axis current i_{q} must be set as zero. In a second active discharge mode (Mode 2), the same torque path is used, but the torque command from the supervisory control processor 148a is overridden by a voltage controller output.

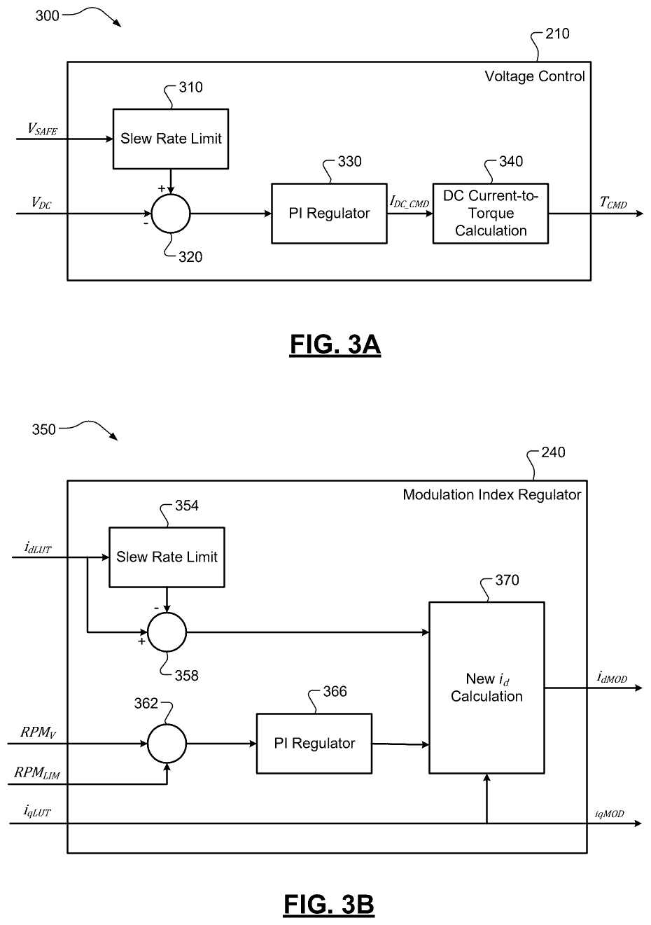

Referring now to FIGS. 3A-3B and with continued reference to the previous figures, functional block diagrams of more example system architectures 300, 350 for the active discharge control system 104 according to the principles of the present application are illustrated. System architecture 300 represents an example embodiment for the voltage control block 210 of FIG. 2. A safe voltage V_{SAFE} works as a voltage reference (via difference calculator 320) for the actual or measured DC voltage V_{DC}. The safe voltage V_{SAFE} is slowly reduced by a slew rate limit 310 to cause a smooth transition and prevent high values of torque request. A proportional-integral (PI) regulator 330 determines the DC current (I_{DC_CMD}) at the capacitor 144 required to obtain the desired voltage. This DC current is then used by a DC current-to-torque calculation block 340 to compute the torque command (T_{CMD}) for the torque path in FIG. 2. When the capacitor or DC bus voltage V_{DC} has been reduced below the lower operating threshold of the MTPA LUT 230, the speed and voltage adjustment block 220 compensates for this low voltage by increasing the motor speed or revolutions-per-minute (RPM). This is done considering the Equations below modelling the motor operation:

$${V}_{s}^{2} = {v}_{d}^{2} + {v}_{q}^{2} = {( {ω}_{e} {L}_{q} {i}_{q} )}^{2} + {( {ω}_{e} {L}_{d} {i}_{d} + {ω}_{e} {λ}_{PM} )}^{2} , and \qquad ( 1 )$$

$${( \frac{{V}_{s}}{{ω}_{e}} )}^{2} = {( {L}_{q} {i}_{q} )}^{2} + {( {L}_{d} {i}_{d} + {λ}_{PM} )}^{2} , \qquad ( 2 )$$

where Vₛ=V_{dc}/\sqrt{3} represents the operating voltage, ωₑ represents the speed in rad/s, and λ_{PM} represents the permanent magnet flux. These Equations define the operation limits through an ellipsoidal representation, where the ratio between voltage and speed defines the range.

Therefore, it is possible to adjust the speed as the voltage is reduced, to guarantee an equivalent operation (the same ratio is kept). In FIG. 2, the speed and voltage adjustment block 220 increases the virtual speed RPM_{V} (without increasing the real motor speed) to compensate for the lower voltage and allow a wider operating range. As an example, if the voltage limits in the LUT 230 are 250-450V, the actual motor speed is 2000 RPM, and capacitor or DC bus voltage is 200V DC, the virtual voltage V_{DCV} will be clamped to the minimum operating voltage V_{DCV}=250 V while the virtual speed will be

$${RPM}_{V} = \frac{2000 RPM}{200 V} .$$

250 V=2500 RPM. In other words, the operating point of 2000 RPM, 200V, is equivalent to the operating point of 2500 RPM, 250V. Finally, if the speed compensation causes a virtual speed above the operating range of the LUT 230, a compensation on the d-axis current i_{d} is implemented to guarantee control stability. FIG. 3B depicts the modulation index regulator block 240 (which could also be described as an “i_{d} current correction block 240”). As shown, the i_{d} current command (i_{dLUT}) is slew rate limited a block 354 and subtracted from itself at difference block 358, and the result is fed to a new i_{d} calculation block 370. In a separate flow, the virtual speed RPM_{V} against the speed limits RPM_{LIM} (using difference block 362 and a PI regulator 366) and the output is also fed to the new i_{d} calculation block 370, which recalculates the new i_{d} reference current (i_{dMOD}) without affecting the i_{q} current command (i_{qMOD}), which equals the original i_{q} current command i_{qLUT}.

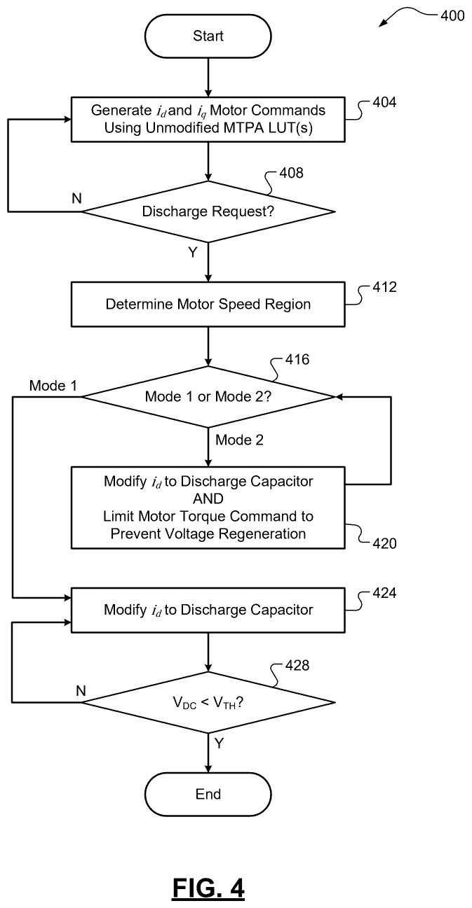

FIG. 4 is a flow diagram of an example active discharge control method for a capacitor of a power inverter module (PIM) of an electrified vehicle according to the principles of the present application. While the method 400 specifically references the electrified vehicle 100 and its components for descriptive/illustrative purposes, it will be appreciated that the method 400 could be applicable to any suitably configured electric or hybrid vehicle having an EDM (or similar electric motor based drive system) with an existing motor control architecture (including LUTs) as discussed herein. The method 400 begins at 404 where the control system 148 generates i_{d} and i_{q} motor commands using the unmodified MTPA LUT(s) 230. At 408, the control system 148 determines whether a discharge request is received or generated. This could occur, for example, in response to a key-off or a crash event of the vehicle 100. When false, the method 400 returns to 404 and the same i_{d} and i_{q} motor control continues (using the existing unmodified MTPA LUT 230). When true, the method 400 proceeds to 412. At 412, the control system 148 determines a speed of the electric motor 128 using the sensors 156 for subsequent determination of the discharge mode.

At 416, the control system 148 determines whether the motor speed is in a low speed region or a high speed region (i.e., above a motor speed threshold). When the motor speed is in the low speed region, the method 400 proceeds to 424 (Mode 1). When the motor speed is in the high speed region, the method 400 proceeds to 420 (Mode 2). At 420, in Mode 2, the control system 148 modifies the i_{d} current command to discharge the capacitor or DC bus voltage through the windings 132 of the electric motor 128 while also limiting the motor torque command to prevent voltage regeneration (e.g., via the permanent magnets and a freewheeling motor situation as discussed previously herein). The method 400 then returns to 416 and this continues until the motor speed falls into the low speed region. At 424, in Mode 1, the control system 148 modifies the i current command to discharge the capacitor voltage through the windings 132 of the electric motor 128. At 428, the control system 148 determines whether the capacitor voltage V_{DC} has been discharged below a voltage threshold V_{TH} (e.g., an isolation voltage threshold of 60V DC). When false, the method 400 returns to 424 where Mode 1 active discharge continues. When true, the method 400 ends.

To briefly summarize, vehicle high voltage DC capacitors need to be quickly bled-off to guarantee hardware and passenger safety, which is particularly critical during a crash scenario. For example, the DC capacitor voltage must be reduced within a time interval of five seconds, as specified by United Nation Vehicle Regulation ECC R94. The DC capacitor will be considered as discharged when its voltage is below a threshold level, such as 60V DC. In conventional electrified vehicle architectures, a discharge resistor is used to bleed the capacitor voltage when an accident is detected. The discharge resistor is expensive, takes up considerable space, and it is heavy, especially in systems using 800V or higher rated voltage. The electric motor could be used as a path for the discharge current when at standstill.

However, if the electric motor is rotating (for instance, freewheeling after a crash), and the electric motor uses permanent magnets, recharging voltage or back-EMF will be produced, and the DC capacitor will be recharged. The recharge voltage depends on the freewheeling speed, but this can be above the 60V limits. The present invention constitutes a control algorithm that discharges the capacitor voltage by means of the electric motor windings. The control strategy also avoids the capacitor to be recharged to a value above a safe voltage due to back-EMF. This invention consists of an algorithm adapted into existing motor control architectures (e.g., the same LUTs) to operate outside of the calibrated voltage range without modifying the existing calibrations. Conventional discharge algorithms require specially designed control architectures, which are not compatible with the existing motor control architectures. These existing motor control architectures can be defined to operate within a limited voltage range, and thus, operation of the MCP at very low voltage would not reliable.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An active discharge control system for an electrified vehicle, the active discharge control system comprising:
an electric drive module (EDM) configured to generate drive torque for propulsion of the electrified vehicle, the EDM comprising a power inverter module (PIM) and an electric motor having a plurality of windings, wherein the PIM comprises a capacitor connected between the electric motor and an energy storage system (ESS) of the electrified vehicle; and
a control system configured to:
generate direct and quadrature current commands, for controlling the EDM, using an unmodified maximum torque per amperage (MTPA) look-up table (LUT) and a torque command based on a driver torque request; and
in response to a discharge request for the capacitor, modify at least one of the direct and quadrature current commands to cause a voltage of the capacitor to discharge through the plurality of windings of the electric motor.

2. The active discharge control system of claim 1, wherein the control system is configured to modify at least one of the current commands to cause the voltage of the capacitor to discharge via at least one of first and second discharge modes, wherein the first discharge mode corresponds to a low speed region for a speed of the electric motor and the second discharge mode corresponds to a high speed region for the speed of the electric motor.

3. The active discharge control system of claim 2, wherein the second discharge mode includes further includes the control system limiting the torque command for the EDM to prevent the capacitor from being recharged by a regenerating mode.

4. The active discharge control system of claim 3, wherein the first discharge mode is initially entered in response to the discharge request or is transitioned to from the second discharge mode when the speed of the electric motor transitions from the high speed region to the low speed region.

5. The active discharge control system of claim 4, wherein the second discharge mode includes the control system increasing at least one of the direct and quadrature current commands output by the MTPA LUT.

6. The active discharge control system of claim 5, wherein the first discharge mode includes the control system increasing the direct current command and setting the quadrature current command to zero.

7. The active discharge control system of claim 6, wherein the control system is configured to discharge the voltage of the capacitor to below a voltage threshold within a time period.

8. The active discharge control system of claim 7, wherein the voltage threshold is approximately 60V DC and the time period is approximately five seconds.

9. The active discharge control system of claim 7, wherein the discharge request is generated in response to a key-off cycle of the electrified vehicle or a crash event of the electrified vehicle.

10. The active discharge control system of claim 1, wherein the ESS comprises at least one of a high voltage battery pack or system and a fuel cell system.

11. An active discharge control method for an electrified vehicle, the active discharge control method comprising:
providing an electric drive module (EDM) configured to generate drive torque for propulsion of the electrified vehicle, the EDM comprising a power inverter module (PIM) and an electric motor having a plurality of windings, wherein the PIM comprises a capacitor connected between the electric motor and an energy storage system (ESS) of the electrified vehicle;
generating, by a control system of the electrified vehicle, direct and quadrature current commands, for controlling the EDM, using an unmodified maximum torque per amperage (MTPA) look-up table (LUT) and a torque command based on a driver torque request; and
in response to a discharge request for the capacitor, modifying, by the control system, at least one of the direct and quadrature current commands to cause a voltage of the capacitor to discharge through the plurality of windings of the electric motor.

12. The active discharge control method of claim 11, wherein the modifying of the at least one of the current commands to cause the voltage of the capacitor to discharge is performed via at least one of first and second discharge modes, wherein the first discharge mode corresponds to a low speed region for a speed of the electric motor and the second discharge mode corresponds to a high speed region for the speed of the electric motor.

13. The active discharge control method of claim 12, wherein the second discharge mode includes further includes the control system limiting the torque command for the EDM to prevent the capacitor from being recharged by a regenerating mode.

14. The active discharge control method of claim 13, wherein the first discharge mode is initially entered in response to the discharge request or is transitioned to from the second discharge mode when the speed of the electric motor transitions from the high speed region to the low speed region.

15. The active discharge control method of claim 14, wherein the second discharge mode includes the control system increasing at least one of the direct and quadrature current commands output by the MTPA LUT.

16. The active discharge control method of claim 15, wherein the first discharge mode includes the control system increasing the direct current command and setting the quadrature current command to zero.

17. The active discharge control method of claim 16, wherein the control system is configured to discharge the voltage of the capacitor to below a voltage threshold within a time period.

18. The active discharge control method of claim 17, wherein the voltage threshold is approximately 60V DC and the time period is approximately five seconds.

19. The active discharge control method of claim 17, wherein the discharge request is generated in response to a key-off cycle of the electrified vehicle or a crash event of the electrified vehicle.

20. The active discharge control method of claim 11, wherein the ESS comprises at least one of a high voltage battery pack or system and a fuel cell system.
